(19) United States
(12) Patent Application Publication
(10) Pub. No.: US 2025/0233284 A1
(43) Pub. Date: Jul. 17, 2025

(54) ENERGY STORAGE CELL

(71) Applicant: VARTA MICROBATTERY GMBH, Ellwangen Jagst (DE)

(72) Inventors: Edward PYTLIK, Ellwangen (DE); Dominik KIENINGER, Rainau (DE); David ENSLING, Ellwangen (DE); Ihor CHUMAK, Ellwangen (DE)

(21) Appl. No.: 18/848,534

(22) PCT Filed: Mar. 22, 2023
(86) PCT No.: PCT/EP2023/057340

§ 371 Date: Sep. 19, 2024

(30) Foreign Application Priority Data
Mar. 22, 2022 (EP) 22163517.0

(51) Int. Cl. H01M 50/533; H01M 10/04; H01M 50/107; H01M 50/152; H01M 50/536; H01M 50/586

(52) U.S. Cl. CPC H01M 50/533; H01M 10/0431; H01M 50/107; H01M 50/152; H01M 50/536; H01M 50/586

(57) ABSTRACT

An energy storage cell includes an electrode-separator assembly with the sequence first electrode/separator/second electrode. The first electrode is ribbon-shaped and includes a first ribbon-shaped current collector with a first longitudinal edge, a second longitudinal edge parallel thereto, a main region loaded with a layer of first electrode material, and a free edge strip extending along the first longitudinal edge and being not loaded with the first electrode material. The second electrode is ribbon-shaped and includes a second ribbon-shaped current collector with a first longitudinal edge and a second longitudinal edge parallel thereto. The second ribbon-shaped current collector is loaded with a layer of second electrode material and at least one metallic arrester strip is fixed to the second ribbon-shaped current collector. The at least one metallic arrester strip fixed to the second current collector protrudes from the first terminal end face of the electrode-separator assembly.

### CROSS REFERENCE TO RELATED APPLICATIONS

This application is a U.S. National Phase application under 35 U.S.C. § 371 of International Application No. PCT/EP2023/057340, filed on Mar. 22, 2023, and claims benefit to European Patent Application No. EP 22163517.0, filed on Mar. 22, 2022. The International Application was published in German on Sep. 28, 2023 as WO 2023/180390 under PCT Article 21(2).

### FIELD

The present disclosure relates to an energy storage cell.

### BACKGROUND

Electrochemical energy storage elements can convert stored chemical energy into electrical energy through virtue of a redox-reaction. The simplest form of an electrochemical energy storage element is the electrochemical cell. It comprises a positive and a negative electrode, which are separated from each other by a separator. During a discharge, electrons are released at the negative electrode as a result of an oxidation process. This results in an electron current that can be drawn off by an external electrical consumer, for which the electrochemical cell serves as an energy supplier. At the same time, an ion current corresponding to the electrode reaction occurs within the cell. This ion current crosses the separator and is made possible by an ion-conducting electrolyte.

If the discharge is reversible, i.e. it is possible to reverse the conversion of chemical energy into electrical energy during discharge and charge the cell again, this is said to be a secondary cell. The common designation of the negative electrode as the anode and the designation of the positive electrode as the cathode in secondary cells refers to the discharge function of the electrochemical cell.

Secondary lithium-ion cells are used as energy storage elements for many applications today, as they can provide high currents and are characterized by a comparatively high energy density. They are based on the use of lithium, which can migrate back and forth between the electrodes of the cell in the form of ions. The negative electrode and the positive electrode of a lithium-ion cell are generally formed by so-called composite electrodes, which comprise electrochemically inactive components as well as electrochemically active components.

In principle, all materials that can absorb and release lithium ions can be used as electrochemically active components (active materials) for secondary lithium-ion cells. For example, carbon-based particles such as graphitic carbon are used for the negative electrode. Active materials for the positive electrode can be, for example, lithium cobalt oxide (LiCoO₂), lithium manganese oxide (LiMn₂O₄), lithium iron phosphate (LiFePO₄) or derivatives thereof. The electrochemically active materials are generally contained in the electrodes in particle form.

As electrochemically inactive components, the composite electrodes generally comprise a flat and/or ribbon-shaped current collector, for example a metallic foil, which serves as a carrier for the respective active material. The current collector for the negative electrode (anode current collector) can be made of copper or nickel, for example, and the current collector for the positive electrode (cathode current collector) can be made of aluminum, for example. Furthermore, the electrodes can comprise an electrode binder (e.g. polyvinylidene fluoride (PVDF) or another polymer, for example carboxymethyl cellulose), conductivity-improving additives and other additives as electrochemically inactive components. The electrode binder ensures the mechanical stability of the electrodes and often also the adhesion of the active material to the current collectors.

As electrolytes, lithium-ion cells generally comprise solutions of lithium salts such as lithium hexafluorophosphate (LiPF₆) in organic solvents (e.g. ethers and esters of carbonic acid).

When manufacturing a lithium-ion cell, the composite electrodes are combined with one or more separators to form an electrode-separator assembly in which the electrodes are connected to each other via the separator. The electrodes and separators are often, but by no means necessarily, connected to each other under pressure, possibly also by lamination or bonding. The basic functionality of the cell can then be established by impregnating the assembly with the electrolyte.

In many embodiments, the electrode-separator assembly is formed in the form of a winding or processed into a winding. In the first case, for example, a ribbon-shaped positive electrode and a ribbon-shaped negative electrode as well as at least one ribbon-shaped separator are fed separately to a winding machine and spirally wound into a coil with the sequence positive electrode/separator/negative electrode. In a winding formed in this way, the electrodes are connected to each other via the separator; gluing or a similarly firm assembly of the electrodes to the separator is not practical in the vast majority of cases. In the second case, a ribbon-shaped positive electrode and a ribbon-shaped negative electrode and at least one ribbon-shaped separator are first combined to form an electrode-separator assembly, for example by applying the aforementioned pressure. In a further step, the assembly is then wound up.

For applications in the automotive sector, for e-bikes or for other applications with high energy requirements, such as in tools, lithium-ion cells with the highest possible energy density are required that are also capable of withstanding high currents during charging and discharging.

Cells for the aforementioned applications are often designed as cylindrical round cells, for example with a form factor of 21×70 (diameter*height in mm) Cells of this type always comprise an assembly in the form of a winding. Modern lithium-ion cells of this form factor can already achieve an energy density of up to 270 Wh/kg. However, this energy density is only considered an intermediate step. The market is already demanding cells with even higher energy densities.

The housing of cylindrical round cells generally comprises a housing cup, which serves to receptable the wound electrode-separator assembly, and a lid component, which closes the opening of the housing cup. A seal is arranged between the lid component and the housing cup, which on the one hand serves to seal the cell housing, but on the other hand also has the function of electrically insulating the lid component and the housing cup from each other. The seal is usually mounted on the edge of the lid component. To close the round cells, the opening edge of the housing cup is generally bent radially inwards over the edge of the lid component enclosed by the seal (crimping process), so that the lid component including the seal is positively fixed in the opening of the housing cup.

WO 2017/215900 A1 describes cylindrical round cells in which the electrode-separator assembly and its electrodes are ribbon-shaped and in the form of a winding. The electrodes each have ribbon-shaped electrodes loaded with electrode material. Oppositely polarized electrodes are arranged offset to each other within the electrode-separator assembly so that longitudinal edges of the current collectors of the positive electrodes protrude from the winding on one side and longitudinal edges of the current collectors of the negative electrodes protrude from the winding on another side. For electrical contacting of the current collectors, the cells have sheet metal parts that sit flat on the end faces of the winding and are assembled by welding to the longitudinal edges of the current collectors. This makes it possible to electrically contact the current collectors and thus also the associated electrodes over their entire length. Cells with windings contacted in this way have a significantly reduced internal resistance. As a result, the occurrence of large currents can be absorbed much better and heat can also be dissipated better from the winding.

In the case of such end face winding contacting, very solid metal contacting sheet metal parts are preferred in order to provide high cross-sections for high electrical and thermal conductivity. However, the use of such contact sheet metal parts naturally also has disadvantages. For example, the weight of correspondingly equipped cells is inevitably elevated and additional conductors are regularly required to further connect the contact sheet metal parts to the housing, which is associated with corresponding volume losses.

### SUMMARY

In an embodiment, the present disclosure provides an energy storage cell. The energy storage cell includes an electrode-separator assembly with the sequence first electrode/separator/second electrode. The first electrode is ribbon-shaped and includes a first ribbon-shaped current collector with a first longitudinal edge, a second longitudinal edge parallel thereto, a main region loaded with a layer of a first electrode material, and a free edge strip extending along the first longitudinal edge and being not loaded with the first electrode material. The second electrode is ribbon-shaped and includes a second ribbon-shaped current collector with a first longitudinal edge and a second longitudinal edge parallel thereto. The second ribbon-shaped current collector is loaded with a layer of a second electrode material and at least one metallic arrester strip is fixed to the second ribbon-shaped current collector. The energy storage cell further includes a housing closed in an airtight and liquid-tight manner. The housing includes a metallic housing cup and a lid. The metallic housing cup includes a bottom and a terminal circular opening, and the lid includes a circular edge that closes the terminal circular opening. The electrode-separator assembly is in a form of a cylindrical winding including a first terminal end face bounded by a first circumferential edge, a second terminal end face bounded by a second circumferential edge, and a winding shell located therebetween. The cylindrical winding includes the first electrode and the second electrode in spirally wound form. The first electrode and the second electrode are arranged within the electrode-separator assembly such that the first longitudinal edge of the first current collector protrudes from the second terminal end face. The at least one metallic arrester strip fixed to the second current collector protrudes from the first terminal end face of the electrode-separator assembly. The electrode-separator assembly is arranged in axial alignment in the housing cup. The at least one metallic arrester strip fixed to the second current collector either: (a) is welded to the lid component or to a pole passing through the lid component, while the first longitudinal edge of the first current collector is welded to the bottom or to a metal sheet resting directly on the bottom, or (b) is welded to the housing cup, while the first longitudinal edge of the first current collector is welded to the lid component or to a pole passing through the lid component or to a metal sheet resting on the first longitudinal edge and being electrically connected to the lid component or to the pole.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates a first embodiment of an energy storage cell according to an embodiment (cross-sectional view); and

FIG. 2 illustrates an electrode-separator assembly, which is part of an energy storage cell according to an embodiment, and its components (top view or perspective view).

### DETAILED DESCRIPTION

The present disclosure provides energy storage cells that are characterized by a high energy density.

According to an aspect of the present disclosure an energy storage cell has the immediately following features a. to j:
a. The cell comprises an electrode-separator assembly with the sequence first electrode/separator/second electrode.
b. The first electrode of the electrode-separator assembly is ribbon-shaped and comprises a first ribbon-shaped current collector having a first longitudinal edge and a second longitudinal edge parallel thereto.
c. The first ribbon-shaped current collector comprises a main region loaded with a layer of a first electrode material and a free edge strip extending along its first longitudinal edge, which is not loaded with the first electrode material.
d. The second electrode of the electrode-separator assembly is ribbon-shaped and comprises a second ribbon-shaped current collector, which has a first longitudinal edge and a second longitudinal edge parallel thereto.
e. The second ribbon-shaped current collector is loaded with a layer of a second electrode material and at least one metallic arrester strip is fixed to the second current collector.
f. The electrode-separator assembly is in the form of a cylindrical winding with a first terminal end face bounded by a circumferential edge and a second terminal end face bounded by a circumferential edge and a winding shell between them and comprises the first and second electrodes in spirally wound form.
g. The first and second electrodes are arranged within the electrode-separator assembly such that the first longitudinal edge of the first current collector protrudes from the second terminal end face.
h. The at least one metallic arrester strip which is fixed to the second current collector protrudes from the first terminal end face of the electrode-separator assembly.
i. The cell comprises an airtight and liquid-tight housing which has a metallic housing cup with a bottom and a terminal circular opening and a lid component with a circular edge which closes the terminal circular opening.
j. The electrode-separator assembly is arranged in axial alignment in the housing cup.

In particular, the energy storage cell is further characterized by one of the following features k. or l:
k. The at least one metal arrester strip fixed to the second current collector is welded to the lid component or to a pole passing through the lid component, while the first longitudinal edge of the first current collector is welded to the bottom or to a metal sheet directly rested on the bottom (variant A), or
l. the at least one metallic arrester strip fixed to the second current collector is welded to the housing cup, while the first longitudinal edge of the first current collector is welded to the lid component or to a pole passing through the lid component or to a metal sheet which rests on the first longitudinal edge and is electrically connected to the lid component or to the pole (variant B).

The cell thus has an asymmetrically contacted winding, which is connected to a housing part via an edge of one of the current collectors, while the other current collector is contacted to a second housing part via the at least one arrester strip.

Preferably, the first end face of the electrode-separator assembly arranged in axial alignment points in the direction of the lid component, while the second end face preferably points in the direction of the bottom of the liquid-tight housing.

The first and second electrodes have opposite polarity. Preferably the first electrode is the negative electrode (anode), the second electrode is the positive electrode (cathode), the first band-shaped current collector is the anode current collector, the first electrode material is a negative electrode material, the second band-shaped current collector is the cathode current collector, and the second electrode material is a positive electrode material.

However, in some alternative preferred embodiments, it may also be preferred that the first electrode is the positive electrode (cathode), the second electrode is the negative electrode (anode), the first ribbon-shaped current collector is the cathode current collector, the first electrode material is a positive electrode material, the second band-shaped current collector is the anode current collector, and the second electrode material is a negative electrode material.

If the housing cup is to form the positive pole of the cell, the cathode current collector is connected to the cup and the anode current collector is connected to the lid or pole bushing. If the housing cup is to form the negative pole of the cell, the anode current collector is contacted to the cup and the cathode current collector is contacted to the lid or pole bushing.

If necessary, two or more arrester strips can be fixed to the second ribbon-shaped current collector, in particular the cathode current collector.

Preferably, the second ribbon-shaped current collector, in particular the ribbon-shaped cathode current collector, is loaded with the layer of the first electrode material, in particular the positive electrode material, and has at least one free section which is not loaded with the electrode material and to which the metallic arrester strip is welded. If necessary, metallic arrester strips are welded to two or more such sections.

In some embodiments, the free section or one of the free sections is a terminal section of the second ribbon-shaped current collector, in particular the cathode current collector, for example the outermost winding in the cylindrical winding. In this case, the metal arrester strip welded to the free section protrudes from the circumferential edge of the first terminal end face.

In many preferred embodiments, however, the free section is not a terminal section but a central section, which means that, in relation to the main direction of extension of the second current collector, current collector sections loaded with electrode material adjoin it on both sides of the section. In this case, the metallic arrester strip welded to the free section protrudes from the winding both at a distance from the center of the winding and at a distance from the circumferential edge of the first terminal end face.

Alternatively, the at least one metallic arrester strip can also be fixed to the coated region of the second current collector, but this generally results in poorer contact resistance.

In preferred embodiments, the energy storage cell has at least one of the three features a. to c. immediately below:
a. The cell comprises an annular seal made of an electrically insulating material which encloses the circular edge of the lid component and electrically insulates the housing cup and the lid component from each other.
b. The housing cup comprises an inner side and an outer side and, in axial sequence, the bottom, a central section and a closure section, wherein the central section is hollow cylindrical and in the central section the winding shell of the electrode-separator assembly in the form of a winding is in contact with the inside of the housing cup, and in the closure section, the annular seal is in press contact with the lid component and the inside of the housing cup.
c. The central section and the closure section are separated by an indentation that circumferentially surrounds the outside of the housing cup.

Preferably, features b. and c. are realized in combination. In particular feature a. can be realized independently of the other features. It is preferred that all three features a. to c. are realized in combination.

In this embodiment, the housing cup and the lid component are electrically isolated from each other and can therefore both serve as poles of the energy storage cell. In cases without the annular seal made of the electrically insulating material, the aforementioned pole guided through the lid component is used. This must then be electrically insulated from the lid component.

In a preferred further embodiment, the energy storage cell has the features a. to n. immediately below:
a. The cell comprises the electrode-separator assembly with the sequence anode/separator/cathode.
b. The anode of the electrode-separator assembly is ribbon-shaped and comprises a ribbon-shaped anode current collector having a first longitudinal edge and a second longitudinal edge parallel thereto.
c. The ribbon-shaped anode current collector comprises a main region loaded with a layer of negative electrode material and a free edge strip extending along its first longitudinal edge which is not loaded with the negative electrode material.
d. The cathode of the electrode-separator assembly is ribbon-shaped and comprises a ribbon-shaped cathode current collector having a first longitudinal edge and a second longitudinal edge parallel thereto.
e. The ribbon-shaped cathode current collector is loaded with a layer of positive electrode material and at least one metallic arrester strip is fixed to the cathode current collector.
f. The electrode-separator assembly is in the form of a cylindrical winding with a first terminal end face bounded by a circumferential edge and a second terminal end face bounded by a circumferential edge and a winding shell lying between them and comprises the anode and the cathode in spirally wound form.
g. The anode and the cathode are arranged within the electrode-separator assembly in such a way that the first longitudinal edge of the anode current collector protrudes from the second terminal end face.
h. The metal arrester strip welded to the cathode current collector protrudes from the first terminal end face of the electrode-separator assembly.
i. The cell comprises an airtight and liquid-tight housing which has a metallic housing cup with a bottom and a terminal circular opening and a lid component with a circular edge which closes the terminal circular opening.
j. The electrode-separator assembly is arranged in axial alignment in the housing cup, with the first end face pointing towards the lid component.
k. The cell comprises an annular seal made of an electrically insulating material, which encloses the circular edge of the lid component and electrically insulates the housing cup and the lid component from each other.
l. The housing cup comprises an inner side and an outer side and, in axial sequence, the bottom, a central section and a closure section, wherein the central section is hollow cylindrical and in the central section the winding shell of the electrode-separator assembly, which is formed as a winding, is in contact with the inside of the housing cup, and in the closure section, the annular seal is in press contact with the lid component and the inside of the housing cup.
m. The central section and the closure section are separated by an indentation that circumferentially surrounds the outside of the housing cup.
n. The metal arrester strip fixed to the cathode current collector is welded to the lid component, while the first longitudinal edge of the anode current collector is welded to the bottom or to a metal sheet directly resting on the bottom.

The use of the arrester strip on the side of the winding facing the lid with simultaneous connection of the anode over the ideally entire longitudinal edge of its current collector offers volumetric advantages, which are beneficial for energy-optimized cells. At the same time, positive effects result from the excellent connection of the anode and thus an improved performance and service life of the cell. The most homogeneous possible electrical and thermal connection of the anode is advantageous for improved fast-charging capability. In this context, the reduced occurrence of lithium plating during fast charging (>2 C) or charging at low temperatures (<0° C.) is to be mentioned.

In a further preferred development, the energy storage cell has the immediately following features a. to n.:
a. The cell comprises the electrode-separator assembly with the sequence anode/separator/cathode.
b. The cathode of the electrode-separator assembly is ribbon-shaped and comprises a ribbon-shaped cathode current collector having a first longitudinal edge and a second longitudinal edge parallel thereto.
c. The ribbon-shaped cathode current collector comprises a main region loaded with a layer of positive electrode material and a free edge strip extending along its first longitudinal edge which is not loaded with the positive electrode material.
d. The anode of the electrode-separator assembly is ribbon-shaped and comprises a ribbon-shaped anode current collector, which has a first longitudinal edge and a second longitudinal edge parallel thereto.
e. The ribbon-shaped anode current collector is loaded with a layer of negative electrode material and at least one metallic arrester strip is fixed to the anode current collector.
f. The electrode-separator assembly is in the form of a cylindrical winding with a first terminal end face bounded by a circumferential edge and a second terminal end face bounded by a circumferential edge and a winding shell lying between them and comprises the anode and the cathode in spirally wound form.
g. The anode and the cathode are arranged within the electrode-separator assembly in such a way that the first longitudinal edge of the cathode current collector protrudes from the second terminal end face.
h. The metallic arrester strip welded to the anode current collector protrudes from the first terminal end face of the electrode-separator assembly.
i. The cell comprises an airtight and liquid-tight housing which has a metallic housing cup with a bottom and a terminal circular opening and a lid component with a circular edge which closes the terminal circular opening.
j. The electrode-separator assembly is arranged in axial alignment in the housing cup, with the first end face pointing towards the lid component.
k. The cell comprises an annular seal made of an electrically insulating material, which encloses the circular edge of the lid component and electrically insulates the housing cup and the lid component from each other.
l. The housing cup comprises an inner side and an outer side and, in axial sequence, the bottom, a central section and a closure section, wherein the central section is hollow cylindrical and in the central section the winding shell of the electrode-separator assembly in the form of a winding is in contact with the inside of the housing cup, and in the closure section, the annular seal is in press contact with the lid component and the inside of the housing cup.
m. The central section and the closure section are separated by an indentation that circumferentially surrounds the outside of the housing cup.
n. The metal arrester strip fixed to the anode current collector is welded to the lid component, while the first longitudinal edge of the cathode current collector is welded to the bottom or to a metal sheet directly resting on the bottom.

The use of the arrester strip on the side of the winding facing the lid with simultaneous connection of the cathode over the ideally entire longitudinal edge of its current collector also offers volumetric advantages, which are beneficial for energy-optimized cells. At the same time, positive effects result from the excellent connection of the cathode and thus an improved performance and service life of the cell.

The electrode-separator assembly is preferably manufactured using two ribbon-shaped separators. Preferably, the assembly has the sequence separator/anode/separator/cathode or anode/separator/cathode/separator. The separator or separators then enclose either the anode or the cathode. Their task is to avoid direct electrical contact between oppositely polarized electrodes within the winding and at the same time to allow an exchange of ions between the electrodes.

The bottom of the housing cup is preferably circular. The housing cup is usually formed by deep drawing. However, it is also possible, for example, to form the cup by welding a bottom into a tubular half part. In the context of the present disclosure, it is also possible to connect a sheet metal part with a circular circumference by welding to the first longitudinal edge of the first current collector protruding from the second terminal end face, ideally in such a way that the longitudinal edge is connected to the sheet metal part over its entire length, and to close one end of the tubular half-part with the sheet metal part in a subsequent step, so that the sheet metal part forms the bottom of the housing cup.

Preferably, the housing cup has a wall thickness in a range from 0.1 mm to 2 mm.

The housing cup may consist of a sheet steel, for example, in preferred embodiments of a nickel-plated sheet steel. Alternatively, stainless steel can be used or, if the polarity is reversed, aluminum, also in the form of an alloy.

The energy storage cell is preferably a cylindrical round cell. Preferably, the height of a cylindrical round cell of the energy storage cell is in a range from 50 mm to 150 mm. Its diameter is preferably in a range from 15 mm to 60 mm. Cylindrical round cells with these form factors are suitable, for example, for supplying power to electric drives in motor vehicles.

### EMBODIMENT AS A LITHIUM-ION CELL

In a preferred embodiment, the energy storage cell is a lithium-ion cell.

Basically, all electrode materials known for secondary lithium-ion cells can be used for the electrodes of the energy storage cell.

Carbon-based particles such as graphitic carbon or non-graphitic carbon materials capable of intercalating lithium, preferably also in particle form, can be used as active materials in the negative electrodes. Alternatively or additionally, lithium titanate (Li₄Ti₅O₁₂) or a derivative thereof can also be contained in the negative electrode, preferably also in particle form. Furthermore, the negative electrode can contain as active material at least one material from the group comprising silicon, aluminum, tin, antimony or a compound or alloy of these materials that can reversibly store and release lithium, for example silicon oxide (in particular SiOₓ with 0<x<2), optionally in combination with carbon-based active materials. Tin, aluminum, antimony and silicon can form intermetallic phases with lithium. The capacity for the receptability of lithium exceeds that of graphite or comparable materials many times over, especially in the case of silicon. Mixtures of silicon and carbon-based storage materials are often used. Thin anodes made of metallic lithium are also suitable.

Suitable active materials for the positive electrodes include lithium metal oxide compounds and lithium metal phosphate compounds such as LiCoO₂ and LiFePO₄. Lithium nickel manganese cobalt oxide (NMC) with the chemical formula LiNi Mn_{xy} Co O_{z2} (where x+y+z is typically 1) is also suitable, lithium manganese spinel (LMO) with the chemical formula LiMn₂O₄, or lithium nickel cobalt aluminum oxide (NCA) with the chemical formula LiNiₓCo_{y}Al_{z}O₂ (where x+y+z is typically 1). Derivatives thereof, for example lithium nickel manganese cobalt aluminum oxide (NMCA) with the chemical formula Li_{1.11}(Ni_{0.40}Mn_{0.39}Co_{0.16}Al_{0.05})_{0.89}O₂ or Li₁₊ₓM—O compounds and/or mixtures of the aforementioned materials can also be used. The cathodic active materials are also preferably used in particulate form.

In addition, the electrodes of an energy storage cell preferably contain an electrode binder and/or an additive to improve the electrical conductivity. The active materials are preferably embedded in a matrix of the electrode binder, with neighboring particles in the matrix preferably being in direct contact with each other. Conductive agents have the function of elevating the electrical conductivity of the electrodes. Common electrode binders are based, for example, on polyvinylidene fluoride (PVDF), (Li-)polyacrylate, styrene-butadiene rubber or carboxymethyl cellulose or mixtures of different binders. Common conductive agents are carbon black, fine graphite, carbon fibers, carbon nanotubes and metal powder.

The energy storage cell preferably comprises an electrolyte, in the case of a lithium-ion cell in particular an electrolyte based on at least one lithium salt such as lithium hexafluorophosphate (LiPF₆), which is present dissolved in an organic solvent (e.g. in a mixture of organic carbonates or a cyclic ether such as THF or a nitrile). Other lithium salts that can be used are, for example, lithium tetrafluoroborate (LiBF₄), lithium bis(trifluoromethanesulfonyl)imide (LiTFSI), lithium bis(fluorosulfonyl)imide (LiFSI) and lithium bis(oxalato)borate (LiBOB).

The nominal capacity of a lithium-ion-based energy storage cell designed as a cylindrical round cell is preferably up to 15000 mAh. With the form factor of 21×70, the energy storage cell in an embodiment as a lithium-ion cell preferably has a nominal capacity in a range from 1500 mAh to 7000 mAh, preferably in a range from 3000 to 5500 mAh. With the form factor of 18×65, the cell in an embodiment as a lithium-ion cell preferably has a nominal capacity in a range from 1000 mAh to 5000 mAh, preferably in a range from 2000 to 4000 mAh.

In the European Union, manufacturers' information on the nominal capacity of secondary batteries is strictly regulated. For example, information on the nominal capacity of secondary nickel-cadmium batteries must be based on measurements in accordance with the IEC/EN 61951-1 and IEC/EN 60622 standards, information on the nominal capacity of secondary nickel-metal hydride batteries must be based on measurements in accordance with the IEC/EN 61951-2 standard, information on the nominal capacity of secondary lithium batteries must be based on measurements in accordance with the IEC/EN 61960 standard and information on the nominal capacity of secondary lead-acid batteries must be based on measurements in accordance with the IEC/EN 61056-1 standard. Any information on nominal capacities in the present application is preferably also based on these standards.

### EMBODIMENT AS SODIUM-ION CELL, POTASSIUM-ION CELL, CALCIUM-ION CELL, MAGNESIUM-ION CELL OR ALUMINUM-ION CELL

In further embodiments, the energy storage element may also be a sodium-ion cell, a potassium-ion cell, a calcium-ion cell, a magnesium-ion cell or an aluminum-ion cell. Among these variants, energy storage cells with sodium-ion cell chemistry are preferred.

Preferably, the sodium ion-based energy storage element comprises an electrolyte comprising at least one of the following solvents and at least one of the following conducting salts:

Organic carbonates, ethers, nitriles and mixtures thereof are suitable as solvents. Preferred examples are: Carbonates: Propylene carbonate (PC), ethylene carbonate-propylene carbonate (EC-PC), propylene carbonate-dimethyl carbonate-ethyl methyl carbonate (PC-DMC-EMC), ethylene carbonate-diethyl carbonate (EC-DEC), ethylene carbonate-dimethyl carbonate (EC-DMC), ethylene carbonate-ethyl methyl carbonate (EC-EMC), ethylene carbonate-dimethyl carbonate-ethyl methyl carbonate (EC-DMC-EMC), ethylene carbonate-dimethyl carbonate-diethyl carbonate (EC-DMC-DEC); Ethers: tetrahydrofuran (THF), 2-methyltetrahydrofuran, dimethyl ether (OME), 1,4-dioxane (DX), 1,3-dioxolane (DOL), diethylene glycol dimethyl ether (DEGDME), tetraethyl glycol dimethyl ether (TEGDME); and Nitriles: Acetonitrile (ACN), adiponitrile (AON), y-butyrolactone (GBL). Trimethyl phosphate (TMP) and tris (2,2,2-trifluoroethyl) phosphate (TFP) can also be used.

Preferred conductive salts are: NaPF₆, sodium difluoro(oxalato)borate (NaBOB), NaBF₄, sodium bis(fluorosulfonyl)imide (NaFSI), sodium 2-trifluoromethyl-4,5-dicyanoimidazole (NaTDI), sodium bis (trifluoromethanesulfonyl) imide (NaTFSI), NaAsF₆, NaBF₄, NaClO₄, NaB(C₂O₄)₂, NaP(C₆H₄O₂)₃, NaCF₃SO₃, sodium triflate (NaTf) and Et₄NBF₄.

In preferred embodiments, additives may be added to the electrolyte. Examples of preferred additives, in particular for stabilization, are the following:

Fluoroethylene carbonate (FEC), transdifluoroethylene carbonate (DFEC), ethylene sulfite (ES), vinylene carbonate (VC), bis(2,2,2-trifluoroethyl)ether (BTFE), sodium 2-trifluoromethyl-4,5-dicyanoimidazole (NaTDI), sodium bis(fluorosulfonyl)imide (NaFSI), aluminum chloride (AICI3), ethylene sulfate (DTD), sodium difluorophosphate (NaPO₂F₂), sodium difluoro(oxalato)borate (NaODFB), sodium difluorobisoxalatophosphate (NaDFOP) and tris(trimethylsilyl)borate (TMSB).

The negative electrode material of an energy storage element based on sodium ions is preferably at least one of the following materials:
carbon, especially hard carbon (pure or with nitrogen and/or phosphorus doping) or soft carbon or graphene-based materials (with N-doping); carbon nanotubes, graphite
Phosphorus or sulphur (conversion anode).
Polyanions: Na₂Ti₃O₇, Na₃Ti₂(PO₄)₃, TiP₂O₇, TiNb₂O₇, Na—Ti—(PO₄)₃, Na—V—(PO₄)₃
Prussian blue: low-Na variant (for systems with aqueous electrolyte).
Transition metal oxides: V₂O₅, MnO₂, TiO₂, Nb₂O₅, Fe₂O₃, Na₂Ti₃O₇, NaCrTiO₄, Na₄Ti₅O₁₂.
MXenes with M=Ti, V, Cr, Mo or Nb and A=AI, Si, and Ga and X=C and/or N, e.g. Ti₃C₂
Organic: e.g. sodium terephthalates (Na₂C₈H₂O₄)

Alternatively, a sodium metal anode can also be used on the anode side.

The positive electrode material of an energy storage element based on sodium ions is, for example, at least one of the following materials:
polyanions: NaFePO₄ (Triphylit-Typ), Na₂Fe(P₂O₇), Na₄Fe₃(PO₄)₂(P₂O₇), Na₂FePO₄F, Na/Na₂[Fe_{1/2}Mn_{1/2}]PO₄F, Na₃V₂(PO₄)₂F₃, Na₃V₂(PO₄)₃, Na₄(CoMnNi)₃(PO₄)₂P₂O₇, NaCoPO₄, Na₂CoPO₄F
silicates: Na₂MnSiO₄, Na₂FeSiO₄
Layered oxides: NaCoO₂, NaFeO₂, NaNiO₂, NaCrO₂, NaVO₂, NaTiO₂, Na(FeCo)O₂, Na(NiFeCo)₃O₂, Na(NiFeMn)O₂, and Na(NiFeCoMn)O₂, Na(NiMnCo)O₂

In addition, the electrodes of an energy storage element preferably contain an electrode binder and/or an additive to improve the electrical conductivity. The active materials are preferably embedded in a matrix of the electrode binder, whereby the active materials are preferably used in particulate form and adjacent particles in the matrix are preferably in direct contact with each other. Conductive agents have the function of elevating the electrical conductivity of the electrodes. Common electrode binders are based on polyvinylidene fluoride (PVDF), (Na-)polyacrylate, styrene-butadiene rubber, (Na-)alginate or carboxymethyl cellulose, for example, or mixtures of different binders. Common conductive agents are carbon black, fine graphite, carbon fibers, carbon nanotubes and metal powder.

Preferably, in an energy storage element based on sodium-ion technology, both the anode and the cathode current collector consist of aluminum or an aluminum alloy. The housing and the contact plates as well as any other current conductors within the housing can also consist of aluminum or the aluminum alloy.

As explained above, the electrode-separator assembly in the form of a cylindrical winding has two terminal end faces, each bounded by a circumferential edge. It is radially bounded by the winding shell mentioned above. This is preferably electrically insulating and can, for example, be formed from several layers of the separator or separators, or from a separate plastic film, in particular a separate plastic adhesive film.

To ensure that the metal arrester strip does not claim too much space inside the housing, it should rest as flat as possible on the first end face.

In a preferred embodiment, the energy storage cell is characterized by at least one of the features a. and b. immediately below:
a. The metal arrester strip fixed to the second ribbon-shaped current collector, preferably welded on, protrudes from the first end face and is bent through an angle of approximately 90° so that it lies essentially flat on the first end face, at least in sections.
b. A plastic film or plastic disk is arranged between the bent arrester strip and the end face to protect the end face from direct contact with the arrester strip.

Such insulation measures are useful to reduce the risk of a short circuit on the first end face due to the bent metal arrester strip.

Further additional or alternative precautions may be expedient. Thus, the energy storage cell is preferably further characterized by at least one of the features a. and b. immediately below:
a. The first end face is formed by a longitudinal edge of the separator and, if necessary, another longitudinal edge of another separator.
b. The longitudinal edge of the separator, which forms the end face, is ceramic reinforced.

In order to prevent direct contact between oppositely polarized electrodes at the axial ends of a winding, separators are preferably used that are slightly wider than the electrode ribbons to be separated. Windings of the type described here therefore preferably end at their axial ends with a separator projection, which forms the end faces accordingly.

In order to protect the end face of the winding from contact with the bent metallic arrester strip, it may be advisable to reinforce the separator(s) with ceramic, as mentioned above.

In a preferred further embodiment, the cell is characterized by the feature a. immediately below:
a. The ceramic reinforcement is provided by at least one particulate ceramic filler material in the separator(s).

The separator can therefore preferably be an electrically insulating plastic film in which the particulate filling material is embedded. It is preferable that the plastic film can be penetrated by the electrolyte, for example because it has micropores. The film can be made of a polyolefin or a polyether ketone, for example. It is not excluded that nonwovens and fabrics made of such plastic materials can also be used. These may also be preferred in individual cases.

The proportion of particulate filler material in the separator is preferably at least 40% by weight, preferably at least 60% by weight.

In a further preferred further development, the cell is characterized by the feature a. immediately below:
a. The ceramic reinforcement is provided by at least one particulate ceramic material present as a coating on a surface of the separator(s).

The separator can therefore preferably also be a plastic film or a fleece or a fabric or another electrically insulating flat structure that is coated with the ceramic filling material.

For example, separators with a base thickness in the region of 5 μm to 20 μm, preferably in a range from 7 μm to 12 μm, are preferably used. The total thickness of the separators results from the base thickness and the thickness of the coating.

In some embodiments, only one side of the sheet structure, in particular the plastic film, is coated with the ceramic material. In further embodiments, the sheet structure, in particular the plastic film, is preferably coated on both sides with the ceramic material.

Where appropriate, it may also be preferred that the separators used comprise a ceramic material as a filler material and the same or a different ceramic material as a coating.

In further possible preferred further developments, the cell is characterized by at least one of the features a. to e. immediately below:
a. The at least one ceramic material/filling material is or comprises an electrically insulating material.
b. The at least one ceramic material/filling material is or comprises at least one material from the group with glass-ceramic material and glass.
c. The at least one ceramic material/filling material is or comprises a lithium ion conductive ceramic material, for example Li₅AlO₄*Li₄SiO₄ or LiAlSi₂O₆.
d. The at least one ceramic material/filling material is or comprises an oxidic material, in particular a metal oxide.
e. The ceramic or oxidic material is aluminum oxide (Al₂O₃), titanium oxide (TiO₂), titanium nitride (TiN), titanium aluminum nitride (TiAIN), a silicon oxide, in particular silicon dioxide (SiO₂) or titanium carbonitride (TiCN).

It is preferred that the immediately preceding features a. to c. or the immediately preceding features a. and b. and d. or the immediately preceding features a. and b. and e. are realized in combination with one another.

Among the materials mentioned, aluminum oxide (Al₂O₃), Titanium oxide (TiO₂) and silicon dioxide (SiO₂) are preferred as coating materials.

In further possible preferred further developments, the cell is characterized by at least one of the features a. and b. immediately below:
a. The separator or separators comprise the at least one ceramic material only in certain areas.
b. The separator or separators have an edge strip along the longitudinal edge forming the first end face, in which they comprise the at least one ceramic material as a coating and/or as a particulate filler material.

It is preferred that the immediately preceding features a. and b. are realized in combination with each other.

It is by no means absolutely necessary for the separator to comprise the ceramic material in a homogeneous distribution or to be evenly coated with the material everywhere. Rather, it may even be preferable for the separator to be free of the ceramic material in certain regions, for example in the main region mentioned. In this region, an elevated thermal resistance of the separator is not needed as much as at the edges of the separator. In addition, the ceramic material can contribute to an unwanted elevation of the internal resistance of the cell, particularly in this region.

It is preferred that the cell is characterized by at least one of the following features a. to c:
a. The housing cup has an identical maximum outer diameter in the central section and the closure section.
b. In the region of the indentation, the outer diameter of the housing cup is reduced by 4 to 20 times the wall thickness of the housing cup in this region.

It is preferred that the immediately preceding features a. and b. are realized in combination.

As already explained above, the first longitudinal edge of the first ribbon-shaped current collector, in particular of the anode current collector, is welded to the bottom of the housing cup or to a metal sheet resting directly on the bottom. The cell can be characterized in a preferred embodiment by the immediately following feature a:
a. The first longitudinal edge of the first current collector protruding from the second terminal end face rests directly on the bottom of the housing cup and is connected to it by welding.

According to an alternative preferred embodiment, the cell is characterized by feature b. immediately below:
b. The cell comprises a metal sheet which is connected by welding to the first longitudinal edge of the first current collector protruding from the second terminal end face and via which this current collector is electrically connected to the bottom of the housing cup.

In both cases, the longitudinal edge of the first current collector protruding from the second terminal end face can ideally be electrically and/or thermally connected over its entire length.

In a possible further embodiment, the metal sheet electrically connected to the first current collector, in particular the anode current collector, is characterized by at least one of the features a. or b. immediately below:
a. The metal sheet consists of nickel or copper or titanium or a nickel or copper or titanium alloy or stainless steel, for example of type 1.4303 or 1.4404 or of type SUS304, or of nickel-plated copper.
b. The metal sheet consists of the same material as the first current collector, in particular the anode current collector.

It is preferred that the immediately preceding features a. and b. are realized in combination.

With regard to the material composition of the metallic arrester strip welded to the cathode current collector, the cell is preferably characterized by at least one of the features a. and b. immediately below:
a. The arrester strip consists of aluminum or an aluminum alloy.
b. The arrester strip consists of the same material as the second current collector, in particular the cathode current collector.

It is preferred that the immediately preceding features a. and b. are realized in combination.

Covering the second end face as extensively as possible is important for the thermal management of the energy storage cell. The larger the cover, the more likely it is to contact the first longitudinal edge of the first current collector, in particular the anode current collector, over its entire length if possible. Heat formed in the electrode-separator assembly can thus be dissipated well via the metal sheet electrically connected to the first current collector.

The anode current collector, the cathode current collector and the separator or separators of the cell preferably have the following dimensions:
A length in a range from 0.5 m to 25 m
A width in a range from 40 mm to 145 mm

It is preferred that, in order to produce the ribbon-shaped electrode-separator assembly, the ribbon-shaped electrodes together with the ribbon-shaped separator(s) are fed to a winding device and are preferably wound up in this device in a spiral around a winding axis. In some embodiments, the electrodes and the separator or separators are wound onto a cylindrical or hollow-cylindrical winding core for this purpose, which is seated on a winding mandrel and remains in the winding after winding.

The current collectors of the energy storage cell have the function of electrically contacting electrochemically active components contained in the respective electrode material over as large an area as possible. Preferably, the current collectors consist of a metal or are at least metallized on the surface.

In the case of a lithium-ion cell, suitable metals for the anode current collector are, for example, copper or nickel or other electrically conductive materials, in particular copper and nickel alloys or metals coated with nickel. In particular, materials of type EN CW-004A or EN CW-008A with a copper content of at least 99.9% can be used as copper alloys. Alloys of the type NiFe, NiCu, CuNi, NiCr and NiCrFe are suitable as nickel alloys. Alloys of the type NiFe, NiCu, CuNi, NiCr and NiCrFe are suitable as nickel alloys. Stainless steel can also be considered, for example type 1.4303 or 1.4404 or type SUS304.

In the case of a lithium-ion cell designed as an energy storage cell, aluminum or other electrically conductive materials, including aluminum alloys, are suitable as the metal for the cathode current collector.

Suitable aluminum alloys for the cathode current collector are, for example, Al alloys of type 1235, 1050, 1060, 1070, 3003, 5052, Mg3, Mg212 (3000 series) and GM55. AlSi, AlCuTi, AlMgSi, AlSiMg, AlSiCu, AlCuTiMg and AlMg are also suitable. The aluminum content of these alloys is preferably above 99.5%.

Preferably, the anode current collector and/or the cathode current collector are each a ribbon-shaped metal foil with a thickness in a range from 4 μm to 30 μm.

However, in addition to films, other ribbon-shaped substrates such as metallic or metallized nonwovens or open-pored metallic foams or expanded metals can also be used as current collectors.

The current collectors are preferably loaded with the respective electrode material on both sides.

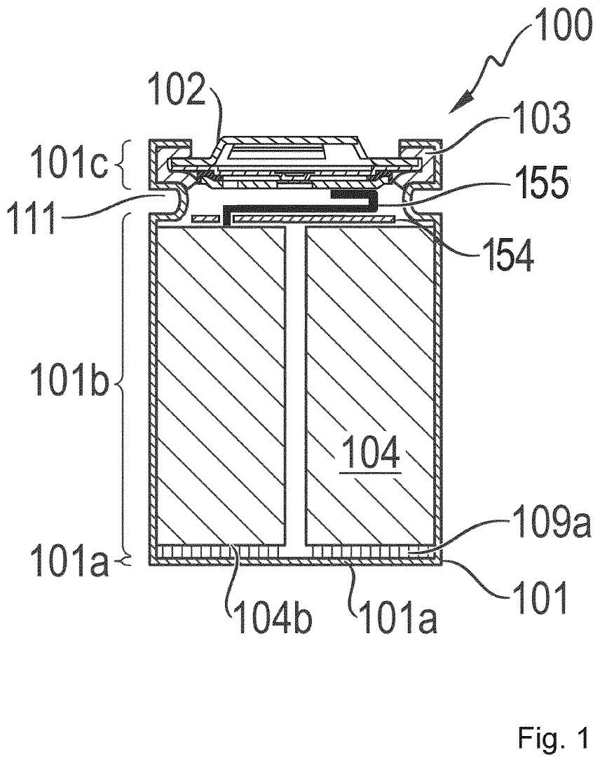

FIG. 1 shows an energy storage cell 100 with an airtight and liquid-tight housing comprising a metallic housing cup 101 with a terminal circular opening and a lid component 102 with a circular edge 102a which closes the circular opening. The cell further comprises a ring-shaped seal 103 made of an electrically insulating material, which encloses the circular edge 102a of the lid component 102 and electrically insulates the housing cup 101 and the lid component 102 from each other. The housing cup 101 comprises in axial sequence a bottom 101a, a central section 101b and a closure section 101c, wherein the central section 101b is cylindrical and in the central section 101b the winding shell 104c of the electrode-separator assembly 104, which is formed as a winding, is in contact with the inside 101d of the housing cup 101, and in the closure section 101c the annular seal 103 is in press contact with the lid component 102 and the inside of the housing cup 101. The central section 101b and the closure section 101c are separated by an indentation 111, which annularly circumferentially surrounds the outer side 101e of the housing cup 101.

The cell 100 also comprises an electrode-separator assembly 104 in the form of a cylindrical winding with the sequence anode/separator/cathode, although this is not shown in detail here. Only the longitudinal edge 106a of the anode current collector 106, which protrudes from the end face 104b of the electrode-separator assembly 104, can be seen. The longitudinal edge 106a is welded directly to the housing bottom 101a, preferably over its entire length. In contrast, the metallic arrester strip 155 welded to the cathode current collector 109 protrudes from the electrode-separator assembly (104) from the first terminal end face 104a. This is bent through an angle of approximately 90°, so that it can rest essentially flat on the first end face, at least in sections. For an improved overview, it is shown here at a distance from the end face, including a plastic disk 154 arranged between the bent-over arrester strip 155 and the end face 104a, which protects the end face 104a from direct contact with the arrester strip 155. In real cells, the arrester strip 155, the plastic disk 154 and the end face 104a may be directly adjacent to each other.

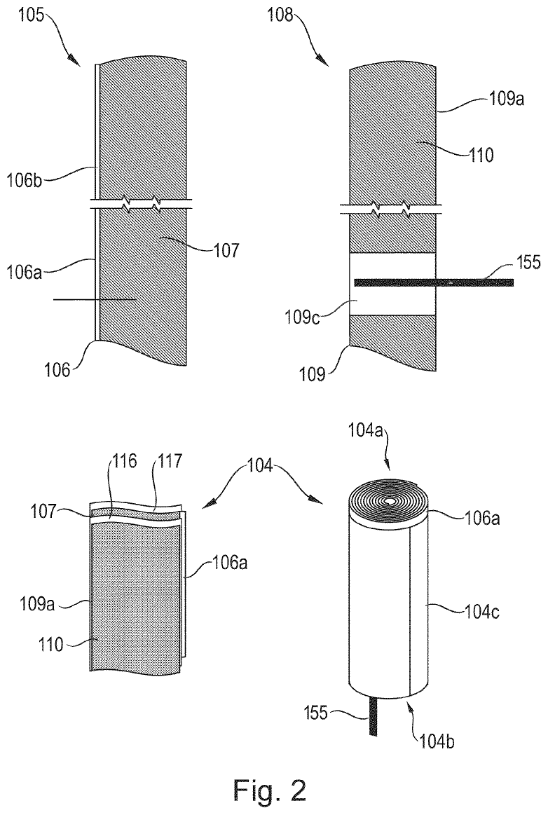

The structure of the electrode-separator assembly 104 is illustrated with reference to FIG. 2. The assembly 104 comprises the ribbon-shaped anode 105 with the ribbon-shaped anode current collector 106, which has a first longitudinal edge 106a and a second longitudinal edge parallel thereto. The anode current collector 106 is preferably a foil made of copper or nickel. This comprises a strip-shaped main region, which is loaded with a layer of negative electrode material 107, and a free edge strip 106b, which extends along its first longitudinal edge 106a and which is not loaded with the electrode material 107. Further, the assembly 104 comprises the ribbon-shaped cathode 108 with the ribbon-shaped cathode current collector 109 having a first longitudinal edge 109a and a second longitudinal edge parallel thereto. The cathode current collector 109 is preferably an aluminum foil. It is loaded with a layer of positive electrode material 110. Furthermore, it has a free section 109c which is not loaded with the electrode material 110 and to which a metallic arrester strip 155 is welded. Both electrodes are shown individually in an unwound state.

The anode 105 and the cathode 108 are arranged offset from each other within the electrode-separator assembly 104, so that the first longitudinal edge 106a of the anode current collector 106 protrudes from the terminal end face 104b. The offset arrangement can be seen in the illustration at the bottom left. The two ribbon-shaped separators 116 and 117, which separate the electrodes 105 and 108 from each other in the winding, are also shown there.

In the illustration at the bottom right, the electrode-separator assembly 104 is shown in wound form, as it can be used in an energy storage cell according to FIG. 1. The longitudinal edge 106a of the anode current collector protruding from the end face 104b is clearly visible. The winding shell 104c is formed by a plastic film.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. An energy storage cell, comprising :
an electrode-separator assembly with the sequence first electrode/separator/second electrode, wherein the first electrode is ribbon-shaped and comprises a first ribbon-shaped current collector with a first longitudinal edge, a second longitudinal edge parallel thereto, a main region loaded with a layer of a first electrode material, and a free edge strip extending along the first longitudinal edge and being not loaded with the first electrode material, and wherein the second electrode is ribbon-shaped and comprises a second ribbon-shaped current collector with a first longitudinal edge, a second longitudinal edge parallel thereto, the second ribbon-shaped current collector is loaded with a layer of a second electrode material and at least one metallic arrester strip is fixed to the second ribbon-shaped current collector; and
a housing closed in an airtight and liquid-tight manner, the housing comprising a metallic housing cup and a lid. wherein the metallic housing cup comprises a bottom and a terminal circular opening, and wherein the lid comprises a circular edge that closes the terminal circular opening.
wherein the electrode-separator assembly is in a form of a cylindrical winding comprising a first terminal end face bounded by a first circumferential edge, a second terminal end face bounded by a second circumferential edge, and a winding shell located therebetween, the cylindrical winding comprising the first electrode and the second electrode in spirally wound form,
wherein the first electrode and the second electrode are arranged within the electrode-separator assembly such that the first longitudinal edge of the first current collector protrudes from the second terminal end face,
wherein the at least one metallic arrester strip fixed to the second current collector protrudes from the first terminal end face of the electrode-separator assembly,
wherein the electrode-separator assembly is arranged in axial alignment in the housing cup, and
wherein the at least one metallic arrester strip fixed to the second current collector is:
welded to the lid component or to a pole passing through the lid component, while the first longitudinal edge of the first current collector is welded to the bottom or to a metal sheet resting directly on the bottom, or
welded to the housing cup, while the first longitudinal edge of the first current collector is welded to the lid component or to a pole passing through the lid component or to a metal sheet resting on the first longitudinal edge and being electrically connected to the lid component or to the pole.

2. The energy storage cell according to claim 1, wherein at least one of:
the cell further comprises an annular seal made of an electrically insulating material that encloses the circular edge of the lid component and electrically insulates the housing cup and the lid component from each other,
housing cup comprises an inner side and an outer side and, in axial sequence, the bottom, a central section and a closure section. wherein
the central section is of hollow cylindrical design and in the central section the winding shell of the electrode-separator assembly, is in contact with the inner side of the housing cup, and
in the closure section, the annular seal is in press contact with the lid component and the inside-inner side of the housing cup, and/or
the central section and the closure section are separated by an indentation that circumferentially surrounds the outer side of the housing cup in an annular manner.

3. The energy storage cell according to claim 1, wherein the first electrode is an anode and the second electrode is a cathode, and
wherein at least one:
the housing cup further comprises an inner side and an outer side and, in axial sequence, the bottom, a central section and a closure section, wherein
the central section is hollow-cylindrical and in the central section the winding shell is in contact with the inner side of the housing cup, and
in the closure section, the annular seal is in press contact with the lid component and the inner side of the housing cup,
the central section and the closure section are separated by an indentation that circumferentially surrounds the outer side of the housing cup in an annular manner, and/or
the metallic arrester strip is connected to the lid component by welding, while the first longitudinal edge of the first current collector is welded to the bottom and/or to a metal sheet directly resting on the bottom.

4. The energy storage cell according to claim 1, wherein at least one of:
the metallic arrester strip protrudes from the first end face and is bent through an angle of approximately 90°, so that, at least in sections, it lies flat on the first end face, and/or
a plastic film or a plastic disk is arranged between the bent arrester strip and the end face.

5. The energy storage cell according to claim 1, wherein at least one of:
the end face is formed by at least one longitudinal edge of the separator, and/or
the at least one longitudinal edge of the separator is ceramically reinforced.
